(19) United States
(12) Patent Application Publication
(10) Pub. No.: US 2006/0285865 A1
(43) Pub. Date: Dec. 21, 2006

(54) Method and apparatus for controlling transfer voltage in image forming device

(75) Inventor: Woo-jung Shim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/455,783

(22) Filed: Jun. 20, 2006

(30) Foreign Application Priority Data
Jun. 20, 2005 (KR) 10-2005-0053074

(51) Int. Cl. G03G 15/16

(52) U.S. Cl. 399/66

(57) ABSTRACT

A method and apparatus for controlling a transfer voltage applied to a transfer roller in order to transfer a toner image formed on an intermediate transfer member to a medium in a multi-path type electrophotographic image forming device are provided. An amount of toner transferred from the photoconductive member to the intermediate transfer member is detected, and a transfer voltage applied to the transfer roller using the detected amount of toner is determined. Accordingly, when an optimum transfer voltage is determined to be applied to the transfer roller in the multi-path type electrophotographic image forming device, by determining the transfer voltage applied to the transfer roller considering the amount of toner detected while the toner image is transferred from the photoconductive member to the intermediate transfer member, an improved printing quality can be maintained regardless of the coverage of an entire printing image.

### CROSS-REFERENCE TO RELATED PATENT APPLICATION

This application claims the benefit under 35 U.S.C. § 119(a) of Korean Patent Application No. 10-2005-0053074, filed on Jun. 20, 2005, in the Korean Intellectual Property Office, the entire disclosure of which is hereby incorporated by reference.

1. Field of the Invention

The present invention relates to an electrophotographic image forming device. More particularly, the present invention relates to a transfer voltage control method and apparatus for determining a transfer voltage applied to a transfer roller considering the amount of toner detected while a toner image is transferred from a photoconductive member to an intermediate transfer member in a multi-path type electrophotographic color image forming device.

2. Description of the Related Art

In general, image forming devices form an image by charging the surface of a photoconductive member using a charger, forming an electrostatic latent image by exposing the photoconductive member using light scanned by a laser scanning unit (LSU) in response to a print signal, forming a toner image using toner supplied by a developing device, and transferring the toner image onto a medium.

Such an image forming device uses a contact charging method of forming a predetermined voltage on the surface of a photoconductive member by contacting the charger with the photoconductive member. To attach toner to an electrostatic latent image formed on the photoconductive member or transfer a toner image from the photoconductive member to an intermediate transfer member, such as an intermediate transfer belt, or from the intermediate transfer member to a medium, a voltage difference between the devices is used.

Thus, if an appropriate transfer voltage is applied to a transfer roller, an image having good quality can be obtained when the toner image formed on the photoconductive member is transferred to the intermediate transfer member or from the intermediate transfer member to the medium.

A method of controlling a transfer voltage to apply an appropriate transfer voltage to a transfer roller according to media types by measuring a resistance of the transfer roller when the leading edge of the medium passes through the transfer roller is disclosed in U.S. Pat. No. 5,682,575 entitled “Electrophotographic Recording Apparatus Having Transfer Voltage Control Device.”

The transfer voltage control method disclosed in U.S. Pat. No. 5,682,575 controls a transfer voltage by detecting a resistance of a transfer roller when a medium does not pass between a photoconductive member and the transfer roller, detecting a synthesized resistance among the medium, the photoconductive member, and the transfer roller by applying a high voltage to the transfer roller when the leading edge of the medium passes between the photoconductive member and the transfer roller, and applying an appropriate transfer voltage to the transfer roller by comparing the previously detected resistance to the synthesized resistance.

FIG. 1 is a graph showing a correlation between the amount of transferred toner and a transfer efficiency when a specific transfer voltage is applied to the transfer roller. As illustrated in FIG. 1, when the amount of transferred toner is less than a reference amount, the transfer efficiency decreases since toner transferred to a medium is reverse transferred after the transfer, and when the amount of transferred toner is greater than the reference amount, the transfer efficiency decreases since the transfer voltage is not sufficient.

Thus, as in a conventional transfer voltage control method, if a transfer voltage is determined considering only media and environmental variations and not transferred toner, quality of a printed image is degraded. Also, the degradation of such printing quality is significantly accelerated for electrophotographic color image forming devices using four colors, such as, cyan, magenta, yellow, and black.

Accordingly, there is a need for an improved method and apparatus for controlling transfer voltage in an image forming device that considers a transferred toner amount.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a transfer voltage control method and apparatus for determining a transfer voltage applied to a transfer roller considering the amount of transferred toner in order to transfer a toner image formed on an intermediate transfer member to a medium in a multi-path type electrophotographic color image forming device.

According to an aspect of exemplary embodiments of the present invention, there is provided a transfer voltage control method, in which an amount of toner transferred from a photoconductive member to an intermediate transfer member is detected; and a transfer voltage applied to a transfer roller using the detected amount of toner is determined.

In an exemplary implementation, the detection of the amount of toner may comprise measuring a transfer current flowing through an intermediate transfer roller when a toner image is not formed on the photoconductive member; measuring a transfer current flowing through the intermediate transfer roller while the toner image formed on the photoconductive member is transferred to the intermediate transfer member; and detecting the amount of toner transferred from the photoconductive member to the intermediate transfer member using a difference between the measured transfer current values.

In an exemplary implementation, the detection of the amount of toner may comprise detecting the amount of toner transferred from the photoconductive member to the intermediate transfer member for each of four colors cyan, magenta, yellow, and black; and summing the detected amount of toner for each of the four colors having a same forming location.

In an exemplary implementation, the determination of the transfer voltage may comprise determining a first transfer voltage applied to the transfer roller using the leading edge of a medium on which toner is not formed; calculating a second transfer voltage applied to the transfer roller using the detected amount of toner; and calculating a transfer voltage applied to the transfer roller by summing the first transfer voltage and the second transfer voltage.

According to another aspect of exemplary embodiments of the present invention, there is provided a transfer voltage control apparatus, in which a current measurement unit measures a first transfer current flowing through an intermediate transfer roller when a toner image is not formed on a photoconductive member and measures a second transfer current flowing through the intermediate transfer roller while the toner image formed on the photoconductive member is transferred to the intermediate transfer member; a memory stores the measured first and second transfer current values; and a voltage determiner determines a transfer voltage applied to a transfer roller considering the amount of toner transferred from the photoconductive member to the intermediate transfer member using a difference between the first and second transfer current values stored in the memory.

According to another aspect of exemplary embodiments of the present invention, there is provided a computer readable medium storing a computer readable program for executing the transfer voltage control method.

Other objects, advantages, and salient features of the invention will become apparent to those skilled in the art from the following detailed description, which, taken in conjunction with the annexed drawings, discloses exemplary embodiments

### BRIEF DESCRIPTION OF THE DRAWINGS

The above and other objects, features, and advantages of the present invention will be more apparent from the following description taken in conjunction with the accompanying drawings, in which:

FIG. 1 is a graph showing a correlation between the amount of transferred toner and transfer efficiency;

FIG. 2 is a cross-sectional view of a multi-path type electrophotographic color image forming device using a transfer voltage control method according to an exemplary embodiment of the present invention;

FIG. 3 is a flowchart illustrating a transfer voltage control method according to an exemplary embodiment of the present invention;

FIG. 4 is a graph showing a measured amount of transfer current flowing through an intermediate transfer roller while a toner image is transferred from a photoconductive member to an intermediate transfer member, according to an exemplary embodiment of the present invention;

FIG. 5 is a graph showing a correlation between a transfer voltage to be applied to a transfer roller and a difference between transfer current values measured while a toner image is transferred from a photoconductive member to an intermediate transfer member, according to an exemplary embodiment of the present invention; and

FIG. 6 is a block diagram of a transfer voltage control apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

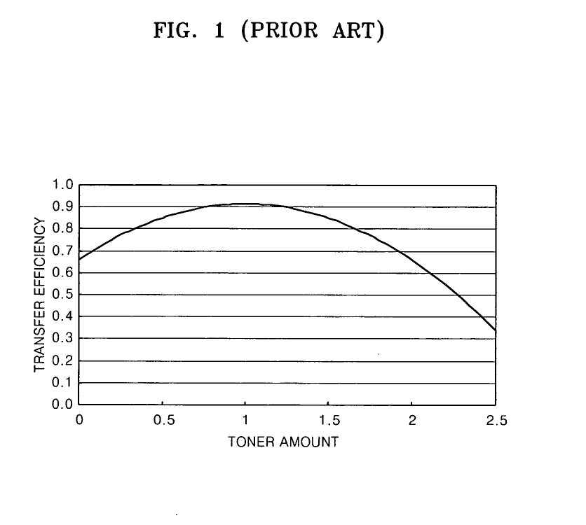

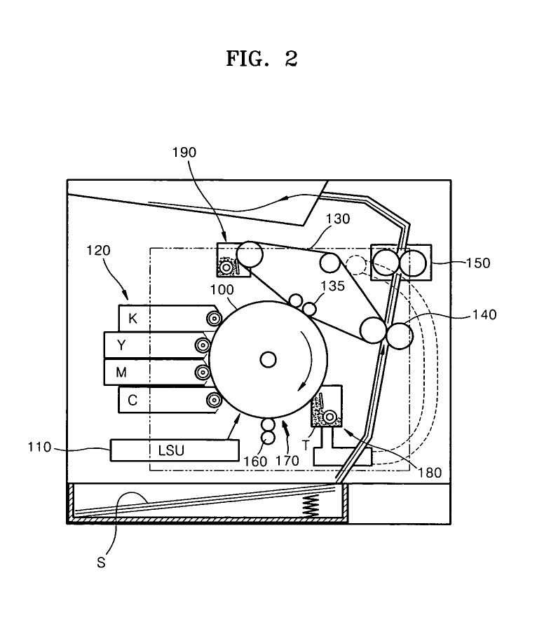

FIG. 2 is a cross-sectional view of an electrophotographic color image forming device according to an exemplary embodiment of the present invention. Referring to FIG. 1, the electrophotographic color image forming device includes a photoconductive member 100, LSU 110, developing unit 120, transfer belt 130, intermediate transfer roller 135, transfer roller 140, fixing unit 150, charger 160, neutralization charger 170, photoconductive member cleaning unit 180, and transfer belt cleaning unit 190.

The charger 160 charges the photoconductive member 100 to have a uniform voltage, and the LSU 110 forms an electrostatic latent image on the photoconductive member 100 by scanning light corresponding to image information onto the photoconductive member 100. The LSU 110 is a type of optical scanning device and scans light onto the photoconductive member 100 using a laser diode as a light source.

Four developing units 120C, 120M, 120Y, and 120K respectively accommodate solid powder toners of cyan, magenta, yellow, and black colors and form a toner image by supplying these toners onto the electrostatic latent image formed on the photoconductive member 100.

The transfer belt 130 is an example of an intermediate transfer member transferring a toner image from the photoconductive member 100 to a medium S. When a voltage is applied to the intermediate transfer roller 135, a color toner image is formed by sequentially transferring and overlapping cyan, magenta, yellow, and black toner images sequentially formed on the photoconductive member 100 onto the transfer belt 130. When the medium S, on which the color toner image is transferred, passes through the fixing unit 150, the color toner image is fixed onto the medium S by heat and pressure.

The transfer roller 140 faces the transfer belt 130, so when a transfer voltage is applied to the transfer roller 140 after the color toner image is fully transferred onto the transfer belt 130, the color toner image formed on the transfer belt 130 is transferred onto the medium S. The neutralization charger 170 discharges a charge remaining on the photoconductive member 100, and the photoconductive member cleaning unit 180 and the transfer belt cleaning unit 190 clean up toner remaining on the photoconductive member 100 and the transfer belt 130, respectively.

An operation of the electrophotographic color image forming device having the configuration illustrated in FIG. 2 will now be described. Color image information is obtained by mixing information regarding cyan, magenta, yellow, and black colors. In an exemplary implementation, a color image is formed by sequentially overlapping cyan C, magenta M, yellow Y, and black K toner images onto the transfer belt 130, transferring the overlapped color toner image onto the medium S, and fixing the transferred color toner image to the medium S.

When the LSU 110 scans an optical signal corresponding to the image information of the cyan color onto the photoconductive member 100 charged with a uniform voltage, a resistance of a light-scanned part decreases, thereby reducing electric charges attached to the outer surface of the photoconductive member 100. Thus, a voltage difference occurs between the light-scanned part and the other part of the photoconductive member 100, thereby forming an electrostatic latent image on the outer surface of the photoconductive member 100. When the electrostatic latent image approaches the developing unit 120C according to the rotation of the photoconductive member 100, cyan toner accommodated in the developing unit 120C is attached onto the electrostatic latent image, thereby forming a cyan toner image on the photoconductive member 100. When the cyan toner image approaches the transfer belt 130 according to the rotation of the photoconductive member 100, the cyan toner image is transferred onto the transfer belt 130 by a difference between the voltage applied to the intermediate transfer roller 135 and the voltage charged on the transfer belt 130 and/or a contact pressure. If the cyan toner image is completely transferred onto the transfer belt 130, by transferring and overlapping magenta, yellow, and black toner images onto the transfer belt 130 through the above described procedures, a color toner image is completely formed. When the medium S passes between the transfer belt 130 and the transfer roller 140, the color toner image is transferred onto the medium S. Then, by fixing the color toner image to the medium S by heat and pressure using the fixing unit 150 and discharging the medium S, a color image is formed.

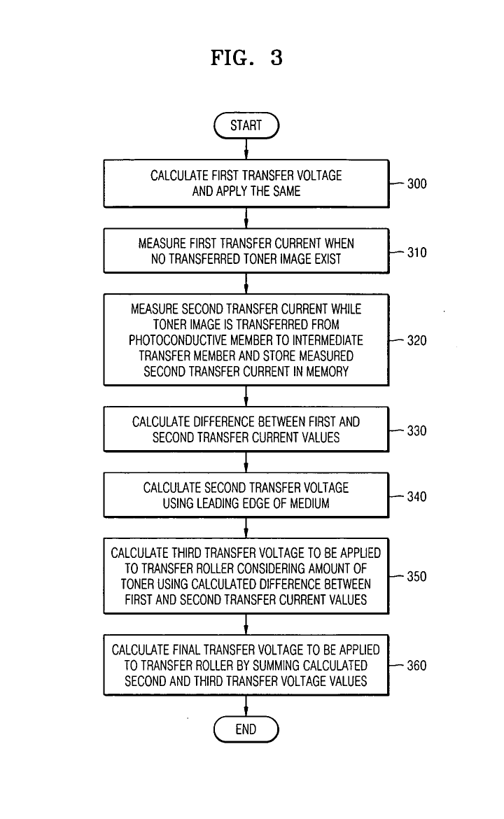

FIG. 3 is a flowchart illustrating a method of controlling a transfer voltage in a multi-path type electrophotographic color image forming device according to an exemplary embodiment of the present invention. The transfer voltage control method illustrated in FIG. 3 will now be described in conjunction with FIG. 6, which is a block diagram of a transfer voltage control apparatus according to an exemplary embodiment of the present invention.

In operation 300, a transfer voltage controller 640 calculates a first transfer voltage to be applied to the intermediate transfer roller 135 in order to transfer a toner image formed on the photoconductive member 100 onto the transfer belt 130, which is an intermediate transfer member, and a transfer voltage apply unit 650 applies the calculated first transfer voltage to the intermediate transfer roller 135. The transfer voltage controller 640 may calculate the first transfer voltage considering resistances of the transfer belt 130, the intermediate transfer roller 135, and the medium S. In detail, the transfer voltage control method disclosed in U.S. Pat. No. 5,682,575 can be used.

In operation 310, when toner image does not exist to be transferred from the photoconductive member 100 to the transfer belt 130, a current measurement unit 600 measures a first transfer current flowing through the intermediate transfer roller 135 according to the first transfer voltage, an analog/digital (A/D) converter 610 converts the measured first transfer current to a digital value, and the converted digital value is stored in a memory 620. The current measurement unit 600 includes a resistor and can measure a transfer current flowing through the intermediate transfer roller 135 by measuring a voltage of both ends of a first transfer system including the intermediate transfer roller 135, the transfer belt 130, and the photoconductive member 100. When a toner image exists to be transferred from the photoconductive member 100 to the transfer belt 130, the measured transfer current is affected by a resistance of the toner to be transferred.

In operation 320, while a toner image is transferred from the photoconductive member 100 to the transfer belt 130, the current measurement unit 600 measures a second transfer current flowing through the intermediate transfer roller 135, the A/D converter 610 converts the measured second transfer current to a digital value, and the converted digital value is stored in the memory 620. In an exemplary implementation, the current measurement unit 600 measures the second transfer current for each of four colors cyan, magenta, yellow, and black, and the measured second transfer currents for the four colors are synchronized based on a specific location, such as the leading edge of the medium S, and stored in an array pattern in the memory 620.

In operation 330, the transfer voltage controller 640 calculates a difference between the first transfer current value and the second transfer current value, which are stored in the memory 620. That is, if the first transfer current value is subtracted from a value obtained by summing the four second transfer current values of the four colors having the same array position, which are stored in the memory 620, a value proportional to the total amount of cyan, magenta, yellow, and black toners at the same array position can be obtained.

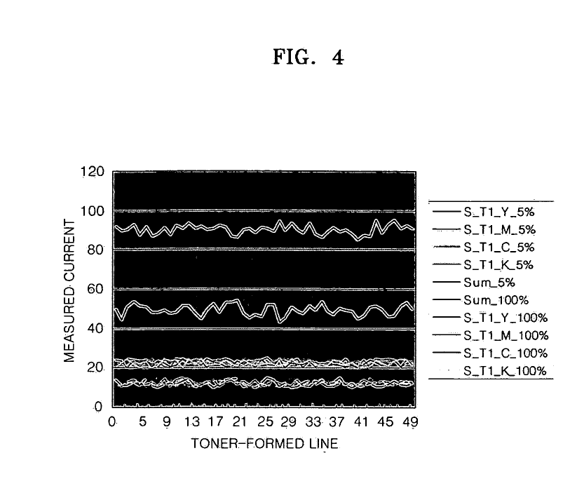

FIG. 4 is a graph showing the amplitude of each transfer current flowing through the intermediate transfer roller 135, which is measured by the current measurement unit 600, along a line on which toner is formed for uniform pattern images whose coverage is 5% or 100%, according to an exemplary embodiment of the present invention. In FIG. 4, S_T1_Y_{—}5% denotes the amplitude of a transfer current measured by the current measurement unit 600 for a uniform pattern image of 5% coverage of yellow color, S_T1_C_{—}100% denotes the amplitude of a transfer current measured by the current measurement unit 600 for a uniform pattern image of 100% coverage of cyan color, and Sum_{—}5% denotes the amplitude of a current obtained by summing transfer current values measured for uniform pattern images of 5% coverage of yellow, cyan, magenta, and black colors. As illustrated in FIG. 4, the amplitude of a transfer current measured by the current measurement unit 600 is proportional to the amount of formed toner. When transfer current values for the four colors are summed, a difference between transfer current values measured according to the amount of formed toner is greater.

In operation 340, when the medium S starts to pass between the transfer roller 140 and the transfer belt 130, the transfer voltage controller 640 calculates a second transfer voltage, considering the resistances of the transfer roller 140, the transfer belt 130, and the medium S using the leading edge of the medium S on which no image is printed. In detail, like the transfer voltage control method disclosed in U.S. Pat. No. 5,682,575, an appropriate transfer voltage may be determined by detecting a resistance of the transfer roller 140 when the medium S does not pass between the transfer roller 140 and the transfer belt 130, detecting a synthesized resistance of the transfer roller 140, the transfer belt 130, and the medium S by applying a high voltage when the leading edge of the medium S passes between the transfer roller 140 and the transfer belt 130, and comparing the previously detected resistance to the synthesized resistance.

In operation 350, the transfer voltage controller 640 calculates a third transfer voltage to be applied to the transfer roller 140 considering the amount of toner using the difference between the first transfer current value and the second transfer current value, which has a value proportional to the amount of toner.

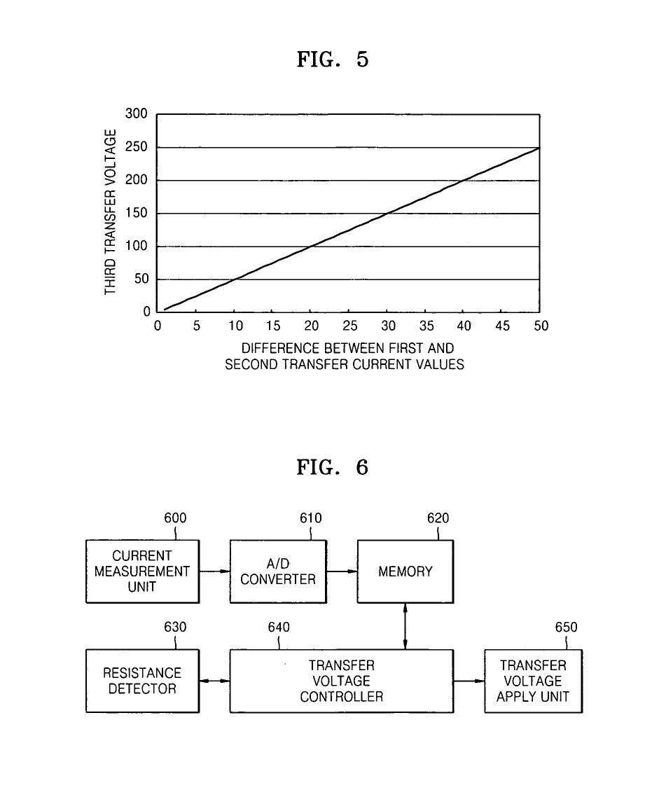

FIG. 5 is a graph showing a correlation between the third transfer voltage and the difference between the first and second transfer current values, which is used to calculate the third transfer voltage in operation 350, according to an exemplary embodiment of the present invention. The correlation between the third transfer voltage and the difference between the first and second transfer current values may be pre-set by analyzing a transfer voltage applied to the transfer roller 140 when printing quality of an image is best while varying the amount of toner. The correlation between the third transfer voltage and the difference between the first and second transfer current values can be set by an equation of first degree as illustrated in FIG. 5, set by an equation of second or third degree, or stored by one-to-one corresponding the third transfer voltage to the difference between the first and second transfer current values using a lookup table.

In operation 360, the transfer voltage controller 640 determines a final transfer voltage to be applied to the transfer roller 140 by summing the calculated second transfer voltage and the calculated third transfer voltage. Thus, the determined transfer voltage is obtained considering the synthesized resistance of the transfer roller 140, the transfer belt 130, and the medium S and the variation of the amount of formed toner. The transfer voltage apply unit 650 may apply the calculated transfer voltage to the transfer roller 140 by completing operation 360 before the toner image formed on the transfer belt 130 is transferred to the medium S.

The invention can also be implemented as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, by a transfer voltage control method and apparatus according to exemplary embodiments of the present invention, when an optimum transfer voltage is determined to be applied to a transfer roller in a multi-path type electrophotographic image forming device, by determining the transfer voltage applied to the transfer roller considering the amount of toner detected while a toner image is transferred from a photoconductive member to an intermediate transfer member, best printing quality can be maintained regardless of the coverage of an entire printing image.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. A method of controlling a transfer voltage applied to a transfer roller in order to transfer a toner image formed on an intermediate transfer member to a medium in a multi-path type electrophotographic image forming device comprising a photoconductive member, the intermediate transfer member, an intermediate transfer roller, and the transfer roller, the method comprising the steps of:
detecting an amount of toner transferred from the photoconductive member to the intermediate transfer member; and
determining a transfer voltage applied to the transfer roller using the detected amount of toner.

2. The method of claim 1, wherein the detecting step comprises:
measuring a transfer current flowing through the intermediate transfer roller when the toner image is not formed on the photoconductive member;
measuring a transfer current flowing through the intermediate transfer roller while the toner image formed on the photoconductive member is transferred to the intermediate transfer member; and
detecting the amount of toner transferred from the photoconductive member to the intermediate transfer member using a difference between the measured transfer current values.

3. The method of claim 1, wherein the detecting step comprises:
detecting the amount of toner transferred from the photoconductive member to the intermediate transfer member for each of four colors cyan, magenta, yellow, and black; and
summing the detected amount of toner for each of the four colors having a same forming location.

4. The method of claim 1, wherein the determining step comprises:
determining a first transfer voltage applied to the transfer roller using the leading edge of the medium on which toner is not formed;
calculating a second transfer voltage applied to the transfer roller using the detected amount of toner; and
calculating a transfer voltage applied to the transfer roller by summing the first transfer voltage and the second transfer voltage.

5. An apparatus for controlling a transfer voltage applied to a transfer roller in order to transfer a toner image formed on an intermediate transfer member to a medium in a multi-path type electrophotographic image forming device comprising a photoconductive member, the intermediate transfer member, an intermediate transfer roller, and the transfer roller, the apparatus comprising:
a current measurement unit for measuring a first transfer current flowing through the intermediate transfer roller when the toner image is not formed on the photoconductive member and measuring a second transfer current flowing through the intermediate transfer roller while the toner image formed on the photoconductive member is transferred to the intermediate transfer member;
a memory for storing the measured first and second transfer current values; and
a voltage determiner for determining a transfer voltage applied to the transfer roller considering an amount of toner transferred from the photoconductive member to the intermediate transfer member using a difference between the first and second transfer current values stored in the memory.

6. A computer readable medium storing a computer readable program for executing a transfer voltage control method of claim 1.
